(19) United States
(12) Patent Application Publication
(10) Pub. No.: US 2026/0086525 A1
(43) Pub. Date: Mar. 26, 2026

(54) Method for Execution of Applications on a Secure System of an Industrial Plant

(71) Applicant: Siemens Aktiengesellschaft, Muenchen (DE)

(72) Inventors: Alexander STEIN, Erlangen (DE); Oliver REMY, Erlangen (DE); Christoph HORN, Erlangen (DE); Michael BAIERLEIN, Erlangen (DE); Alexander LOMAKIN, Erlangen (DE)

(21) Appl. No.: 19/334,702

(22) Filed: Sep. 19, 2025

(30) Foreign Application Priority Data
Sep. 23, 2024 (EP) 24201942

(51) Int. Cl. G05B 19/05; G06F 21/62

(52) U.S. Cl. CPC G05B 19/056; G06F 21/629; G05B 2219/23266

(57) ABSTRACT

A computer-implemented method, a computer-implemented device, a system and a computer program product for executing an application on a secure system of an industrial plant, wherein the method includes receiving, by the secure system, at least one instruction associated with the application, interpreting and/or compiling, by the secure system, the at least one instruction in order to transfer the instruction to the application, and verifying, by the secure system, the application obtained.

### BACKGROUND OF THE INVENTION

### 1. Field of the Invention

The present invention relates to a computer-implemented method, a computer-implemented device, a system and a computer program product for executing an application on a secure system.

### 2. Description of the Related Art

The execution of software, such as control software, on an industrial unit (for example, a machine used to manufacture products) is often subject to particular requirements. In order to prevent an undesired software malfunction, it is necessary to always be able to ensure that the software is run under controlled conditions.

Problems when running software under controlled conditions can result, for example, from corruption of transmitted data packets from a development unit (for example, a developer PC) to the industrial unit. This can result, for example, at least partly, from an inadequate signal quality of the data transmission used (wired or wireless). In addition or as an alternative, unwanted integrity violations can be caused by unauthorized third parties, which can influence a program sequence of corresponding software in an undesirable and possibly undefined manner.

Even if software has been transferred from a development unit to the industrial unit without violating the integrity of the data packets, the software may still be in an unpredictable state during the program sequence. This may be the case, for example, if a calculation of a sequence step by a processor executing the software is incorrect. In some cases, a malfunction of the hardware used may result in the software in question being executed incorrectly.

This suggests that running software on a secure system requires a variety of complex framework conditions to be met so as to ensure that the software in question can always be run in a controlled manner. This results in complex and laborious software development and/or running of the software. This can in turn be accompanied by a laborious, costly development process of the software in question and/or by the fact that the functional scope of the software in question is limited in order to counteract a possible malfunction through reduced functionality in this way.

Ensuring controlled software running may also require a variety of tests during the software development process (for example, in order to be able to detect a possible malfunction at an early stage and in order to be able to provide appropriate routines in the software to be developed, which can counteract such a malfunction). In addition or as an alternative, development guidelines can be formulated, based on which the development is to occur.

If, on the other hand, generic software is used, coded processing is not usually possible without technical obstacles, because essential functions are missing, such as floating-point numbers, trigonometric functions, arrays, loops, and/or if-else constructs). Coded processing can be understood as a method for increasing the execution security of computer programs used, in particular, in safety-critical applications. It can extend functional program codes by arithmetic coding of variables, constants and operations. This method enables the detection of transient, permanent, and systematic errors during program execution, including hardware and software execution errors. Coded processing is independent of hardware and provides continuous end-to-end protection of the program execution. It can be designed to run on standard hardware and achieve a high level of diagnostic coverage.

From the point of view of a user, it is therefore always necessary to choose between self-development of software with a high level of effort but, if necessary, a full range of functions and a generic programmable solution with a limited range of functions. This suggests that current solutions for running software on a secure system do not always provide the desired functionality.

There is therefore a need to improve the controlled and deterministic running of software in an industrial context.

### SUMMARY OF THE INVENTION

In view of the foregoing, it is therefore an object of the present invention to improve the security and reliability of the running of software on a secure system.

This and other objects and advantages are achieved in accordance with the invention by a computer-implemented method for executing an application on a secure system of an industrial plant. The computer-implemented method may include the secure system receiving at least one instruction associated with the application and the secure system interpreting and/or compiling the at least one instruction in order to transfer the instruction to the application. Furthermore, the computer-implemented method may include the secure system verifying the application obtained.

An industrial plant can be understood in the present disclosure as a part (for example, a machine) of an industrial production line. The industrial production line can be characterized by the fact that it contributes significantly to the processing of one or more reactants into a product.

In some cases, the receiving step may also include performing an integrity check. The integrity check may include a cyclic redundancy check (CRC). This can ensure that a possible corruption of the data packet associated with the transmission occurring during the transmission of the at least one instruction can be determined and thus a possible change in the at least one instruction does not remain undetected.

Interpretation can be understood as a process in which an instruction written in a higher programming language is analysed by an interpreter at runtime and executed directly, rather than being translated into machine language beforehand. A provided interpreter can analyse the source code associated with the instruction line by line and execute it immediately. This can enable flexible and dynamic execution of programs because changes to the source code take effect immediately, without the need for recompilation. Interpretation can provide simple troubleshooting and platform-independent execution because the same source code can be interpreted on different systems.

Compilation can be understood as a process in which at least one instruction written in a higher programming language is translated into machine language or a machine-oriented code that can be executed directly by a computer. This process can be performed by a specific program, a compiler, which can be deployed accordingly. The compilation process can include multiple phases, including lexical analysis, syntactical analysis, semantic analysis, code optimization, and code generation. The result of the compilation can be an executable program or an object file that can be executed more efficiently and faster than, for example, interpreted code. Compiled applications can provide better performance and security because the source code is not available at runtime. The compilation process can detect early detection of errors in the source code and can make optimizations and thus improve the efficiency and performance of the resulting application.

Verification may include systematically checking and ensuring that an application (or part of the application) correctly and fully meets specified requirements and has been developed in accordance with predefined standards. This process may include activities and methods including, but not limited to, conducting unit tests, integration tests and system tests at various levels to check functionality, conducting code reviews, and inspecting the source code systematically for errors and adherence to programming standards, an application of static code analysis to automatically check the source code for potential problems and security gaps, checking compliance with industry standards and regulatory requirements, analysing artefacts, such as documentation, specifications, and design documents for completeness and correctness, and ensuring requirements are traceable throughout the development process. Verification can aim to identify and resolve errors early in the development cycle, to improve code quality, and to ensure that the application obtained meets the defined specifications.

Currently used secure systems often have the disadvantage that they only allow a (significantly) reduced range of functions. This can be caused at least in part by the fact that these are often based on integer arithmetic. This can be accompanied by reduced calculation accuracy, reduced usability for scientific applications and calculations, a limited number range available for calculations, memory overflow issues, scaling problems, and increased complexity in implementing workarounds.

By transferring the at least one instruction to the secure system and interpreting and/or compiling the at least one instruction on the secure system, it is possible to ensure that the application obtained meets the security standards of the secure system and, for example, is no longer negatively affected by a transmission (for example, via a communication channel) of the application obtained. In this way, an efficient and deterministic execution of the application obtained can be ensured on the secure system and thus on the industrial plant.

In accordance with one embodiment, the receiving step may include receiving the at least one instruction as a string. The string can result from the serialization of at least one instruction.

By receiving the at least one instruction as a string, an efficient transfer of the relevant at least one instruction can be made possible, because this does not require complex computational operations, for example, does not require conversion into a binary representation.

In accordance with another embodiment, the application may be a generic application. A generic application within the meaning of the present invention refers to an application (for example, a computer program or a software component) structured to be able to operate with a variety of data types without having to implement a source code for each specific data type separately. This application is characterized by high reusability by enabling the code to be used for different data types without duplication or modification. Despite flexibility, the generic application can guarantee type safety at compile time and work with abstract data types that are specified only when they are actually used.

The application can handle different types of data as long as they meet certain predefined requirements, which can improve their flexibility. By avoiding code duplication, the generic application can help to increase efficiency by reducing a codebase and improving maintainability. The implementation of such applications can be made possible using concepts, such as generics, templates or parametric polymorphism.

Using a generic application can enable developers to create more flexible and reusable software components that can be used in different contexts without having to reimplement the code for each specific use case. This can contribute to improved, more targeted code adaptation over time.

In accordance with another embodiment, the secure system may comprise a secure calculation unit and an intermediate language compiler. The secure calculation unit can be provided with more than one processor or more than one central processing unit (CPU).

An intermediate language compiler can be understood as a software system that translates source code (for example, the at least one instruction) of a high-level language into a platform-independent intermediate language before it is converted into executable machine code (for example, by interpretation and/or compilation). This intermediate language compiler can perform a multi-stage transformation of the source code, starting with lexical and syntactical analysis, followed by the generation of an abstract syntax tree and the creation of the intermediate language. The resulting intermediate language represents a machine-independent representation of the application that can be optimized and further processed for various target platforms. The intermediate language compiler can include type checking, error handling, and metadata generation mechanisms that may be useful for later execution or further processing of the intermediate language. By using an intermediate language, the intermediate language compiler can support efficient cross-platform development by creating a common basis for different source languages and target architectures, thus reducing the complexity of code generation for multiple platforms.

This can efficiently contribute to the secure execution of the application obtained. The use of an intermediate language compiler allows the development of the at least one instruction in text form (for example, compared to development in assembler code), which can contribute to improved quality and improved error prevention during development.

In accordance with another embodiment, the receiving step can include receiving from a developer unit, preferably via a programmable logic unit (PLC).

The developer unit may, for example, be provided as a computer provided with means for developing the at least one application. The development means may include, for example, an editor (for software or instruction or application development) and/or a software development kit (SDK). In some cases, the developer unit may also be provided as a server, tablet, and/or smartphone. The developer unit may be physically separate from the industrial plant and may access the industrial plant via an Internet and/or an intranet (wireless and/or wired).

A programmable logic unit (PLC) can be understood as a digital control apparatus that may be specifically designed for use in industrial automation environments. The PLC may include a microprocessor, memory modules for program and data storage, input and output interfaces for communication with external devices and sensors, and a robust housing design suitable for industrial environments. The PLC may be configured to execute user-defined control programs that are written in a specific programming language, such as ladder logic, function block diagram or structured text, for example. It can handle the real-time processing of signals and the control of processes by cyclically processing the stored program.

Furthermore, the separation of the developer unit and the secure system on the development process of at least one instruction or the received application can be further simplified. This may result, for example, from the fact that a developer is no longer required to go through complex certification processes that are required for software development (especially when using floating-point numbers).

In typical applications with floating-point numbers, a safety developer usually only has mathematical basic functions (for example, addition, and/or subtraction) available. More complex mathematical functions must usually be implemented in integer arithmetic in a complex manner and subsequently also certified. Many of these functions can now be delivered already certified, at least in part, on a secure execution platform based on the computer-implemented method presented here, such that certification can be limited to the correct use of these functions and thus simplified.

In this way, a logical and also spatial separation of instruction or application development and corresponding instruction execution can be achieved. This can lead overall to an increase in the efficiency of execution and/or development, as the units associated with the execution and/or development can be optimized for their respective use. In addition, there is no need to meet strict requirements in the development of the instructions in terms of the secure execution of the application in question, as the application is interpreted or compiled only on the secure system. In particular, this can also lead to the development of the at least one instruction in a development environment on, for example, the developer unit, which is already known to the developers themselves and thus provides them with a known environment.

In accordance with another embodiment, the at least one instruction may comprise a floating-point number calculation rule, for example preferably a trigonometric function.

A trigonometric function can be understood, for example, as the calculation of a sine, cosine, tangent, cotangent and/or their respective inverse functions (as a function of a parameter provided, which is used as argument for the respective trigonometric function).

The calculation, using the trigonometric function, may be associated with, for example, a movement of a robot arm and/or a rotation of an entity of the industrial plant.

In particular, this can enable the calculation of floating-point number arithmetic. The use of the computer-implemented method presented herein is not limited solely to trigonometric functions, but may also include additions, subtractions, multiplications and/or divisions of floating-point numbers. It may also be possible to perform appropriate floating-point-number-based operations using powers, roots and/or logarithmic functions. However, the method presented herein is not limited to these mathematical operations, but may also be applied to other mathematical functions.

The use of a floating-point-number arithmetic can offer advantages in that it always allows a constant relative accuracy of executed operations, whereas this is usually not the case with integer operations (for example accuracy may depend on how large integer input variables used are).

Therefore, in order to achieve meaningful results in the case of integer arithmetic, it may be necessary to manually scale the values used. The scaling factor must be determined taking into account the maximum value range in order to avoid overflows, often depending on the actual value. It may subsequently be necessary to continue using scaled values. It may be necessary to make sure that a back-scaled or rescaled operation is performed before an operation that can lead to an overflow. This necessary handling of integer values is time-consuming, error-prone and produces a very high test and certification outlay. This makes the resulting application difficult to read and therefore difficult to maintain.

This can make it possible to overcome the limitation of the coded processing commonly used in the context of developing secure applications to integer calculations (integers) and, in particular, also to calculate floating-point-number-based applications. This makes it possible to efficiently expand the functionality of preserved applications.

In accordance with another embodiment, the secure system may comprise a secure control unit, preferably for an industrial production unit. The control unit may be configured to control at least one subprocess of a manufacturing process associated with the industrial plant (for example, a movement of a robot arm, and/or a belt speed of a conveyor belt), where the subprocess can be performed, for example, by the industrial production unit (as part of the industrial plant). In this way, a control application can be securely executed on a particular controller.

In accordance with another embodiment, the computer-implemented method may furthermore comprise adapting the application at runtime, via a human-computer interface, to situational requirements, preferably without reinterpreting and/or recompiling the at least one instruction.

Adapting the application can refer to setting a parameter associated with executing the application. In some cases, it may be possible, for example, to adapt situational parameters of a control application (such as storing a product definition with regard to the product to be produced via the industrial plant, and/or setting an ambient temperature) without having to reinterpret and/or recompile the application.

The human-computer interface may be provided as a microphone, speaker, keyboard, mouse, touch screen and/or as another suitable input or output means.

In this way, an efficient adaptation of the application to situational conditions (and at the runtime of the application) can be achieved without having to forego secure execution of the application and/or having to accept a time-consuming interpretation and/or compilation of the application.

In accordance with another embodiment, a command sequence associated with the application obtained may be unchangeable.

The order of the commands associated with the application obtained may be static, i.e., it may not be possible to change the order after interpreting or compiling the at least one application. Possible application modification options can be limited, for example, to individual parameter adjustments (for example at runtime).

This can support the immutability of the application obtained and prevent subsequent (unwanted) modification of the application. Thus, the secure execution of the application obtained can be further supported, and undefined and unwanted states of the application obtained can be prevented when it is run.

In accordance with a further embodiment, the computer-implemented method further comprises executing the application obtained, where the execution includes in each case calculating a calculation rule on at least two separate processors, preferably on at least two separate central processing units (CPUs) of the secure system. The computer-implemented method may further comprise determining whether the at least two calculations are identical and establishing that the calculation is reliable when it has been determined that the at least two calculations are identical. The at least two processors may be part of a secure calculation unit.

Possible calculation discrepancies between the at least two CPUs may be caused, for example, by radiation damage (for example, caused by neutron impacts on a semiconductor material of at least two CPUs) in the semiconductor material of the at least two CPUs.

This means that the secure system may contain more than one processor core or more than one CPU. The thus at least two available processor cores can be configured so that they are redundant in relation to one another and can perform a redundant calculation of the calculation rule. The redundant calculation of the calculation rule can be used to compare the results obtained in this way and to be able to conclude a possible incorrect calculation of the calculation rule by at least one of the processor cores and to be able to correct the incorrect calculation in question before it is possibly associated with consequences for a production sequence of the industrial plant.

In accordance with another embodiment, the computer-implemented method may comprise initiating, at least partially based on the application obtained, cyclic communication between the secure system and the developer unit and/or the PLC.

Cyclic communication can be understood in the present case as communication between the secure system and the developer unit and/or the PLC, which communication is characterized in that each communication initiated by a transmitter is characterized by a corresponding confirmation message, by a receiver, which confirms the error-free receipt of the communication.

In this way, even after obtaining the application, subsequent secure communication between the secure system and a developer unit and/or the PLC can be made possible, such that data and/or information exchange with an executed application can also be made possible.

The objects and advantages are also achieved in accordance with the invention by a computer program product. The computer program product may comprise commands which, when the program is executed by a computer, cause the computer to execute the computer-implemented method as described herein.

A computer program product, such as a computer program means, for example, may be provided or delivered, for example, as a storage medium such as a memory card, a USB stick, a CD-ROM, a DVD, for example, or else in the form of a file downloadable from a server in a network. This may occur, for example, in a wireless communication network via transmitting an appropriate file comprising the computer program product or the computer program means.

The objects and advantages are further achieved in accordance with the invention by a computer-implemented device for executing an application on a secure system of an industrial plant. The computer-implemented device may include a receiving unit for receiving via the secure system at least one instruction associated with the application and an interpretation unit for interpreting and/or a compilation unit for compiling via the secure system the at least one instruction to transfer the instruction to the application. Furthermore, the computer-implemented device may include a verification unit for verifying via the secure system the application obtained.

The respective unit, for example, the receiving unit and/or the interpretation unit and/or the compilation unit and/or the verification unit, may be implemented in the form of hardware and/or also in the form of software. In the case of an implementation in the form of hardware, the respective unit may be in the form of a device or part of a device, for example, in the form of a computer or a microprocessor or a control computer of a vehicle. In the case of an implementation in the form of software, the respective unit may be in the form of a computer program product, a function, a routine, part of a program code or an executable object.

A secure system can be understood as a system that implements a variety of security strategies and measures to ensure the availability of the system and its resources, to prevent unauthorized access to the system and its data, and to prevent unauthorized changes to system components and information. The system may include protective mechanisms against external attacks and internal threats that cover both the hardware and software components and the data processed therein. It may include the confidentiality, integrity and availability of information stored and processed in the system through the implementation of authentication mechanisms, including, but not limited to, strong passwords and multi-factor authentication, regular and automated security updates, the use of network security technologies such as firewalls, the integration of malware detection and defence mechanisms, and the use of data encryption technologies. In addition, the system has self-protection mechanisms that enable cryptographic signing of system components and ensure encrypted storage of the operating system and critical data. Finally, the system may include adaptive security mechanisms that are continuously monitored for new threats and vulnerabilities and can be dynamically adapted to changing security requirements.

The secure system may also be provided such that it reliably and deterministically executes an application passed to it for execution. This may include, for example, automatic and reliable stopping of a process, for example, of the application, if it is ascertained that an undefined and/or undesirable state has occurred in the running of the application. In addition or as an alternative, a movement sequence of a robot arm and/or crane can be ensured, for example, based on the secure system.

The computer-implemented device may further comprise an execution unit for executing the computer program product as described herein and/or an additional execution unit for executing the steps of the computer-implemented method as described herein.

The execution unit and/or the additional execution unit may be provided, for example, as a computer, a processor, a field-programmable gate array (FPGA) or a combination thereof.

The objects and advantages are further achieved in accordance with the invention by a system for executing an application on a secure system of an industrial plant. The system may comprise the computer-implemented device as described herein and the computer program product as described herein.

The computer program product may be contained in the computer-implemented device. In alternative examples, the computer program may also be contained in a unit remote from the computer-implemented device. In the latter case mentioned by way of example, the computer-implemented device can use a network (for example a local network or the Internet) or a USB connection to access the computer program product.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further advantageous configurations and aspects of the invention are the subject of the dependent claims and the exemplary embodiments of the invention that are described below. The invention is explained in more detail below on the basis of preferred embodiments with reference to the attached figures, in which:

FIG. 1 shows an exemplary industrial system;

FIG. 2 shows an exemplary flowchart of a sequence for executing an application in accordance with the invention;

FIG. 3 shows an exemplary flowchart of a computer-implemented method in accordance with the invention;

FIG. 4 shows an exemplary computer-implemented device in accordance with the invention; and

FIG. 5 shows a system in accordance with the invention.

### DETAILED DESCRIPTION OF THE EXEMPLARY EMBODIMENTS

In the figures, identical or functionally identical elements have been provided with the same reference signs, unless indicated otherwise.

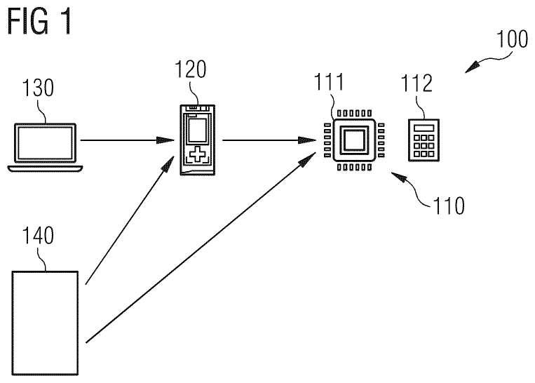

FIG. 1 shows an exemplary industrial system 100 which shows an interaction between the components described herein.

The industrial system 100 comprises a secure system 110 as described herein. The secure system 110 may comprise a calculation unit 111 and (optionally) a control unit 112. The calculation unit 111 may comprise one or more processor cores or central processing units (CPUs).

The industrial system 100 may further comprise a programmable logic unit (PLC) 120. The PLC 120 can be in unidirectional communication with the secure system 110, i.e., communication between the PLC 120 and the secure system 110 can be set up so that data is only sent from the PLC 120 to the secure system 110, but not vice versa. As an alternative, the PLC 120 and the secure system 110 can also be provided such that they can be in bidirectional communication with one another.

The industrial system 100 may further comprise a developer unit 130. The developer unit 130 can be provided, as described herein, for example as a computer (for example, as a PC), which is provided with a software development environment.

In some cases, the developer unit 130 can communicate directly with the secure system 110 (not shown in FIG. 1). However, in addition or as an alternative, the developer unit 130 can communicate with the secure system 110 via the PLC 120. In the latter case, the PLC 120 can thus act as a relay for data that is to be sent from the developer unit via PLC 120 to the secure system 110 (and/or vice versa).

The industrial system may further comprise a human-computer interface 140. The human-computer interface 140 can be provided as described herein.

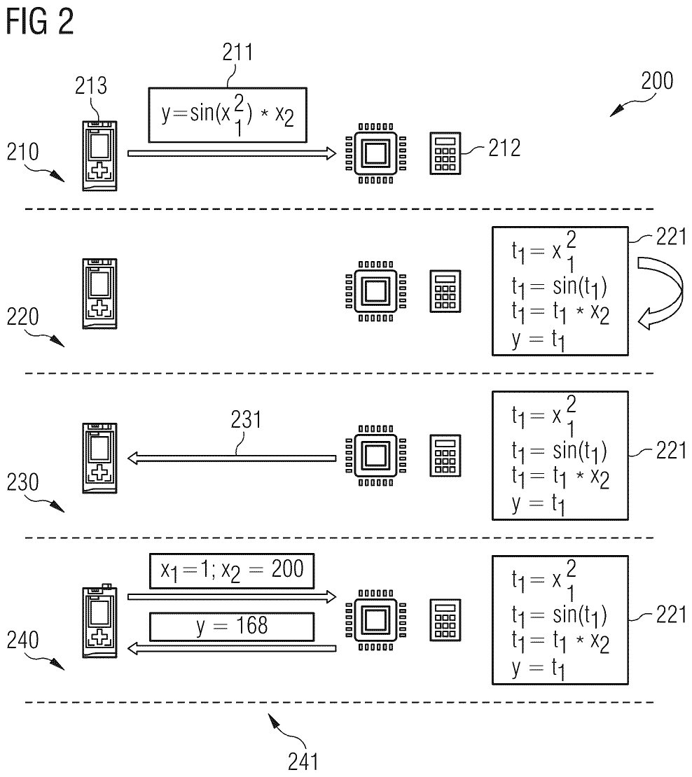

FIG. 2 shows an exemplary flowchart of a sequence 200 for executing an application 221 on a secure system 212. The sequence comprises a first sequence step 210, in which at least one instruction 211 as described herein is provided and this comprises, for example, a calculation rule, for example, a trigonometric function, such as

$$y = sin ( {x}_{1}^{2} ) \cdot {x}_{2} .$$

The instruction 211 can be provided by a developer unit 213 (which may be provided in an identical manner to the developer unit 130) and/or a PLC 213 (as described herein).

The sequence 200 further comprises a second sequence step 220. The secure system 212 can be provided such that it converts the at least one statement 211 by interpreting and/or compiling the instruction 211 into an application 221. The application 221 may include a sequence of commands so that the instruction 211 can be processed by the secure system 212. In some cases, the interpretation and/or compilation may also include a breakdown of the instruction 211. The instruction 211 can be divided into the terms

$${t}_{1} = {x}_{1}^{2} ,$$

t₁=sin (t₁), t₁=t₁·x₂ and y=t₁, which can run through in this order when the application 221 is executed.

The sequence 200 further comprises a third sequence step 230. In sequence step 230, the application 221 is verified 231. The verification 231 can be performed by communication with the developer unit 213 (or the PLC). The verification 231 may include determining whether the application 221 obtained has the functionality envisaged by the design of the at least one instruction 211 (in its development).

The sequence 200 may further comprise a fourth sequence step 240. In the fourth sequence step 240, cyclic communication 241 can occur between the secure system 212 and the developer unit 213 and/or a PLC 213. The cyclic communication 241 may be implemented as described herein.

The cyclic communication can be configured, for example, such that the developer unit 213 and/or the PLC 213 transmit the two values x₁=1 and x₂=200 to the secure system 212 with the request for calculation of a value y, based on the application 221. Based on the values x₁ and x₂ obtained, the secure system 212 can determine the value y using the application 221. In the case discussed here, this results in the value y=168. This can subsequently be transmitted from the secure system 212 to the developer unit 213 or the PLC 213.

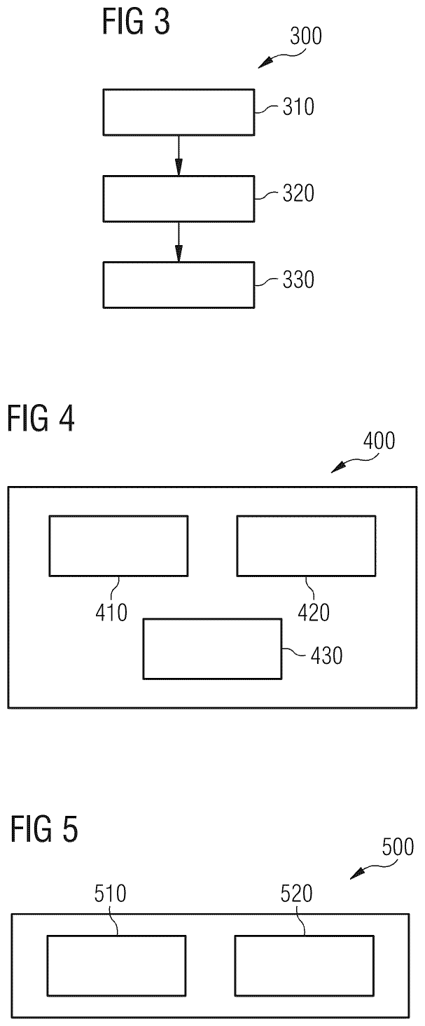

FIG. 3 shows a flowchart of an exemplary computer-implemented method 300 for executing an application on a secure system of an industrial plant.

In step 310, the secure system receives at least one instruction associated with the application.

In step 320, the secure system interprets and/or compiles the at least one instruction in order to transfer the instruction to the application.

In step 330, the secure system verifies the application obtained.

FIG. 4 shows an exemplary computer-implemented device 400 for executing an application on a secure system of an industrial plant. The computer-implemented device 400 comprises a receiving unit 410, an interpretation unit or a compilation unit 420 and a verification unit 430.

The receiving unit 410 is configured to receive via the secure system at least one instruction associated with the application.

The interpretation unit and/or the compilation unit 420 is configured to interpret and/or compile, respectively, via the secure system the at least one instruction in order to transfer the instruction to the application.

The verification unit 430 is configured to verify via the secure system the application obtained.

FIG. 5 shows an exemplary system 500 for executing an application on a secure system of an industrial plant. The system 500 includes a computer-implemented device 510 and a computer program product 520.

The computer-implemented device 510 may be configured as described herein.

The computer program product 520 may be configured as described herein.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A computer-implemented method for executing an application on a secure system of an industrial plant, the method comprising:
receiving, by the secure system, at least one instruction associated with the application;
interpreting and/or compiling, by the secure system, the at least one instruction to transfer the instruction to the application; and
verifying, by the secure system, the application obtained.

2. The computer-implemented method as claimed in claim 1, wherein the receiving step includes receiving the at least one instruction as a string.

3. The computer-implemented method as claimed in claim 1, wherein the application is a generic application.

4. The computer-implemented method as claimed in claim 2, wherein the application is a generic application.

5. The computer-implemented method as claimed in claim 1, wherein the secure system comprises a secure calculation unit and an intermediate language compiler.

6. The computer-implemented method as claimed in claim 1, wherein the receiving step includes receiving the at least one instruction associated with the application from a developer unit via a programmable logic unit (PLC).

7. The computer-implemented method as claimed in claim 1, wherein the at least one instruction comprises a floating-point number calculation rule comprising a trigonometric function.

8. The computer-implemented method as claimed in claim 1, wherein the secure system comprises a secure control unit for an industrial manufacturing unit.

9. The computer-implemented method as claimed in claim 1, further comprising:
adapting the application at runtime, via a human-computer interface, to situational requirements without at least one of reinterpreting and recompiling the at least one instruction.

10. The computer-implemented method as claimed in claim 1, wherein a command sequence associated with the application obtained is unchangeable.

11. The computer-implemented method as claimed in claim 1, further comprising:
executing the application obtained, said executing including in each case calculating a calculation rule on at least two separate processors of the secure system;
determining whether the at least two calculations are identical; and
establishing that the calculation is reliable upon determining that the at least two calculations are identical.

12. The computer-implemented method as claimed in claim 11, wherein at least two separate processors comprise at least two separate central processing units (CPUs).

13. The computer-implemented method as claimed in claim 1, further comprising:
initiating, at least partially based on the application obtained, cyclic communication between the secure system and at least one of the developer unit and a programmable logic unit (PLC).

14. A computer program product stored on memory and comprising commands which, when executed by a computer, cause the computer to implement the computer-implemented method as claimed in one of claim 1.

15. A computer-implemented device for executing an application on a secure system of an industrial plant, the device comprising:
a receiving unit for receiving via the secure system at least one instruction associated with the application;
at least one of (i) an interpretation unit for interpreting and (ii) a compilation unit for compiling via the secure system the at least one instruction to transfer the instruction to the application; and
a verification unit for verifying via the secure system the application obtained.

16. The computer-implemented device as claimed in claim 15, further comprising:
at least one of:
(i) an execution unit for executing a computer program product; and
(ii) an additional execution unit;
wherein the additional execution unit is configured to:
receive at least one instruction associated with the application;
at least one of interpret and compile the at least one instruction to transfer the instruction to the application; and
verify the application obtained.

17. A system for executing an application on a secure system of an industrial plant, the system comprising: the computer-implemented device as claimed in either of claim 15; and
a computer program product stored in memory and comprising commands which, when executed by a computer, cause the computer to:
receive at least one instruction associated with the application;
at least one of interpret and compile the at least one instruction to transfer the instruction to the application; and
verify the application obtained.
